(19) United States
(12) Patent Application Publication
(10) Pub. No.: US 2012/0016859 A1
(43) Pub. Date: Jan. 19, 2012

(54) Method/system for prior art searching

(76) Inventor: Christopher Nordby Sears, Annapolis, MD (US)

(21) Appl. No.: 13/200,353

(22) Filed: Sep. 23, 2011

Related U.S. Application Data
(62) Division of application No. 12/007,966, filed on Jan. 17, 2008.

(51) Int. Cl. G06F 17/30

(52) U.S. Cl. 707/706; 707/E17.108

(57) ABSTRACT

An automated method/system used over an extended time period implemented by an information technology (IT) system for determining “prior art” relating to an inventive concept. Such information can facilitate drafting an invention disclosure from this initial invention concept using steps and means for parsing either an invention statement, using an automated iterative search protocol of the prior art. The invention is used for continual search the prior art as to novelty of an inventive concept from an initial invention statement written in normal sentences and entered into the IT system. Also, the invention can be used for determining undiscovered prior art during a post patent grant period to challenge or correct validity of a patent in view of new prior art findings.

### CROSS-REFERENCE TO RELATED APPLICATIONS

This application is a divisional application of prior application Ser. No. 12/007,966, now U.S. patent Ser. No. ______ and claims priority from U.S. Provisional Patent Application Ser. No. 60/900,110 filed Feb. 8, 2007, Ser. No. 60/935,110, filed Jul. 26, 2007 and Ser. No. 60/996,047 filed Oct. 26, 2007 and Ser. No. 61/006,418 filed Jan. 11, 2008, all are hereby incorporated by reference.

### BACKGROUND OF THE INVENTION

1. Field of the Invention

The invention relates to a business method/system for searching a proposed invention over an extended time period using an information technology (IT) system.

2. Description of the Prior Art

Many inventors in the world today do not actively research U.S./World patents and/or technical literature at an initial conception/disclosure phase when creating an invention to determine whether patenting is warranted, or design around others' patented products/services. This phase of inventing, known as a “pre-examination or novelty search,” use public domain information concerning worldwide patent literature or technical literature data sources, commonly known as “prior art.” By definition, words in quotations are well known in the U.S. patent profession and or define words as used in the claims of the instant invention.

When an invention disclosure is ultimately filed as a patent application, without review of the prior art by the pre-examination search of an initial invention concept, often results in an unpatentable patent application when examined. This is because patent examination of any application reveals pertinent “prior art” that anticipates and/or renders obvious the proposed invention. Patent professionals, such as a patent agent/attorney, before or during preparation of a patent application will generally not actively search the prior art, since it is not required by law or regulation in the U.S. and most foreign countries. Patent professionals often recommend, but do not require such a search be undertaken. This often results in wasted time and money to either the small inventor or business organization. Moreover, the United States Patent and Trademark Office is now overwhelmed with backlogs of applications, such that it now takes 3-5 years to obtain a patent from an initial filing date, since many patent applicants do not provide enough information to acknowledge what is novel about their invention, which would be revealed if an intensive prior art search were undertaken prior to filing.

Today, many inventors do not actively search patent databases in both the world and/or technical literature during an initial invention conception or detailed disclosure phase when seeking patent protection to determine if patenting is worthwhile, or find solutions to problems that design around others' patented inventions based upon corresponding patents. This phase of making and using the invention, if published (as either a patent or published patent application), is important when preparing an invention disclosure as to making and using the invention. This legal requirement is known as “enablement” of the invention, as required under 35 USC 112.

From my own experience, I previously was a U.S. patent examiner and patent agent, and maintain a professional engineer status. Approximately a third of the applications I examined were abandoned. Today, over 300,000 applications are filed annually and about half issue as patents, although the USPTO has over 700,000 pending applications and the time period for issuance is approximately 3-5 years as discussed above. One of the many reasons patent applications do not become issued patents is because the prior art was not reviewed prior to filing of a utility patent application in the U.S., European Patent Office (EPO) or Patent Cooperation Treaty (PCT) authorities wherein either the patent examination authority either undiscovered prior art germane to independent claims in the patent application or published application during examination (note U.S. is now proposing to conform to international standards of an opposition to do as such). Often, many issued patents were narrow in scope as to technical advantage over the prior art discovered by the patent examiner, and/or could be readily designed around by competitors.

In summary, if a thorough search of the prior art is not undertaken of a proposed final version of an invention disclosure is ignored, inventor(s) preclude the benefit of designing around, modifying aspects, or incorporating others' inventions when preparing their own invention disclosure, which could either broaden the scope of a claimed invention that is derived from an initial invention concept, or assist in marketing of the invention with other's patent, published patent application by assignment, license/cross-licensing, resulting potentially as a new business, provide enhanced products and/or services where joint ventures are undertaken.

Moreover, pitfalls of not using the patent literature when companies produce services and/or products unaware of undiscovered patents, can incur costly patent judgments, when initial prior art considerations are ignored by not conducting a thorough validity search prior to producing and selling a product or service. For example, Microsoft Inc. had a judgment of $1.52 billion in 2007 for infringement damages to Alcatel/Lucent MP3 music playing technology (owner of the infringing patent, although Microsoft previously had licensed this technology from a consortium that developed the MP3 technology. Later, such a suit was brought by Alcatel/Lucent and prevailed since Microsoft was unaware of the patent, which some estimate to be over a hundred times above a fair market royalty for such technology. Recent appellant decisions have overturned this, since such a damage award was excessive and unfounded, overturned on appeal. Thus, ignorance of the prior art is no excuse as to patent infringement judgments. Note the U.S. Congress has proposed legislation to correct this problem by limiting damages to the patentable aspect of the invention.

Also, most inventors do not appreciate the legal ramifications of an issued patent since any patent can have a nuisance value, and cost consumers more since it represents a liability to the public in view of its legal expense to a business. This is because any issued U.S. patent has a “presumption of validity,” when issued. This provides a patentee an avenue to litigate infringement issues of a subject patent, sometimes resulting in excessive unwarranted expense to an unwary alleged infringer. If during such a legal proceeding, an alleged infringer finds newly undiscovered prior art that potentially can invalidate the claimed invention in either an administrative or judicial forum, since this undiscovered prior art was never reviewed during patent application preparation from a final invention disclosure, prosecution and examination phase, the unexpected can result to an unwary defendant.

For example, a recent infringement lawsuit of a U.S. patent and well known is a lawsuit against a Canadian company known as Research in Motion's (RIM) product known as “Blackberry” PDA device. This patent infringement case was settled in 2006. As a brief history, a jury initially found for the plaintiffs issued patent in a lower federal court ruling. Subsequent appellant court findings found for the plaintiffs patent, although invalid after the USPTO re-examination determined that the subject patent(s) was invalid. The plaintiffs patent(s), during reexamination at this administrative review discovered prior art not reviewed during examination of the patents. The judicial court ignored the USPTO findings and had the parties make settlement. In summary, RIM paid over $600M to the patentee, although an invalid patent can have some value.

Ways of correcting an invalid issued U.S. patent in the USPTO, in view of undiscovered prior art issues requires filing either a “reexamination” or narrowing “reissue” patent application by a third party and/or patentee respectively, which is an administrative approach. Alternatively, a judicial approach can correct a U.S. patent in the U.S. Court system, where a U.S. patent in either “infringement” or “declaratory” judgment based suit can be totally/partially held to be invalid by judicial decree. Such actions often run in the millions of dollars to litigants regardless of dispute outcome.

Other prior art teachings that provide ways of documenting an invention disclosure include U.S. Pat. No. 6,298,327. Published U.S. Patent Applications 20020065676 A1 teaches of an integrated local area network (LAN) and wide area network (WAN) for an integrated approach for processing intellectual property (IP) in a business setting, somewhat comparable to the U.S. Pat. No. 6,298,327.

U.S. published patent applications 20070220041 A1, 20070124166 A1 and 20070233605 A1, teach of software database/internet structures using plug-in software applications by licensing/cross-licensing agreement, that form aspects of an integrated patent drafting tool (PDT), while using the Internet to conduct most transactions in a WAN-based system such as prior art searches, as discussed in FIG. 2 (Prior Art) below, where IT solutions is more of the basis of U.S. commerce today.

Prior art teachings relevant to the present invention, that can be a plug-ins, as taught in U.S. published patent application 20070124166 A1, when using the instant invention can be in either sophisticated modifications to functions of a Web browser application or be optional features in a stand-alone “container application”, either which can assist lay person inventors/scientist/engineers alike in focusing on ways of preparing an invention disclosure that will provide for stronger patent protection by acknowledgement of what is well known in the prior art when conducting prior art searches by an improved search strategy as a functional aspect with software aspects of the instant invention. One includes ways of documenting a patent disclosure. In particular, U.S. Pat. No. 6,418,457 teaches of a patent disclosure storage and processing system for time-stamping and witnessing date of innovation, a business practice still of import today in the U.S. patent system since it is one of the last WIPO members to do so based upon awarding patent rights to those who are “first-to-invent.” Other countries under World intellectual property Organization (WIPO) use a “first-to-file” basis to determine inventorship of a claimed invention (a.k.a. race to the patent office). U.S. inventorship laws may change soon in view of recent proposed changes of U.S. Patent law to harmonize with other countries of the world under WIPO.

Next, U.S. Pat. No. 7,296,015 teaches of an automated way of finding products/services of any patent document (U.S. and/or EPO) by doing infringement searches using search engine technologies by parsing keywords of an independent claim(s) of a subject patent, resulting in findings of would be infringers. The technique uses various database search engine technologies and/or use of patent examination authorities such as the USPTO, PCT or EPO, which the instant invention uses to develop a better search strategy for finding patents as an improvement upon discussed below.

Other relevant inventions include U.S. Pat. No. 6,574,645, and related family of patents, which in particular teaches of ways of enabling inventors to prepare their patent application, also commercially available now in software entitled “PatentPro,” by Kernel. Publications related to ways of instructing a layperson include “Patent Pending in 24 Hours” 4^{th} edition and “Patent it Yourself by David Pressman, 12^{th} edition 2006.

Optionally, commercially available and/or patented software, which can be adjunct feature(s) with the instant invention, as discussed in the detailed description be incorporated as part of add-on features of an Internet Web browser application or plug-in software application(s) using an exemplary container application software format (by either subscription of a commercial service, assignment, licensed/cross licensed agreements of other's IP technology), e.g. Patent Hunter™ and Patent Wizard™ made by Neustel Law Services, which assist in patent data logging and storage when conducting prior art searches when drafting a final invention disclosure, the benefit of the instant invention.

As a disclaimer, claim drafting, current patent application content issues generally require a patent attorney/agent professional to protect the invention concept and also provide inventor(s) feedback as to issues that may not be understood when using the instant invention.

However, none of these prior patents/products enable inventor(s), during the drafting of their invention disclosure, a better way of focusing aspects that allege to be novel and unobvious for patent protection to develop a better disclosure to further prepare a stronger patent application (provisional or utility) based upon their initial “conception of invention.” The instant invention provides a way to efficiently and effectively prepare the final invention disclosure by iteratively reviewing and updating prior art information to either broaden aspects of their initial invention concept and/or modify the content of prior art teachings so as to strategically design around others patented inventions that may be still active or be in the public domain when drafting the final version of the invention disclosure, and/or determine whether preparation of the final invention disclosure is worth pursuing in view of recent published prior art while drafting initial versions of final patent disclosure, as suggested by U.S. published patent application 20070124166 A1, but does not discuss how inventor(s) from an initial stage of conception of invention can produce the invention disclosure that is based upon iterative interrogation of development of technical data pools of patentability, enablement and enhancement issues taught by the prior art.

### SUMMARY AND ADVANTAGES OF THE INVENTION

A method/system for searching the prior art of an invention by documenting and organizing pertinent “prior art” into patentability, enablement and enhancement technical data pools. Each of these pools consist of public documents in the public domain as defined below as “prior art”, by discovering what is well known, and using new information that is discovered iteratively to efficiently and effectively draft and develop a final version of an invention disclosure document from an initial invention concept (conception of invention). The method of the instant invention provides an integrated approach for drafting the final invention disclosure by use of advanced keyword search engine methods using the instant invention's two step approach of finding one or more “key technical documents” so as to provide an efficient searching and filtering technique of the prior art, which can be inclusively by technical and/or patent literature information to form these data pools. From iterative searching in real time during development of the invention disclosure, the informational data pools are documented and organized into the patentability, enablement and enhancement data pools that assist the inventor(s) for drafting the final invention disclosure document. This is what iterative enhancement provides when editing various versions of the invention to synthesize the final invention disclosure from an initial inventive concept. Each of these searches are documented and referenced when drafting the final invention disclosure.

In exemplary form, the computer based invention provides a business method/software/system approach for inventor(s) to draft the invention disclosure based upon “iterative enhancement” using a unique search strategy while conducting real-time search of the prior art that may or may not use patented technology to achieve a desired result. The method is automated so one can either be computer directed so that newly discovered prior art detects prior art rendering the invention concept moot and/or provide active determination of using public domain technology (expired or have unpaid maintenance fees of patents) to incorporate as a way of enabling aspects of the invention that as a whole be undertaken as to the patentability data pool using automated means for developing the invention disclosure from the initial inventive concept (“conception of invention” as discussed below). Benefits derived by using the method of the invention include: a better final invention disclosure, since inventor(s) learn about others ideas from previously undiscovered prior art and/or recent published patent publications and technical literature, while preparing the final version of the invention disclosure. Accordingly, the invention may have one or more of the following advantages:
a) Provides an efficient synthesis-based business method/system to iteratively draft a final invention disclosure in view of any initial invention concept (conception of invention), using a method of patent literature searching using search engine approach of both patent and technical literature databases accessible over the Internet using free or commercial based databases to determine prior art, to initially determine scope of innovation using a method of searching the prior art using advance search engine technology;
b) Promotes potential assignment, licensing and/or cross-licensing of any conceived invention that may result when seeking patent protection with third parties since any invention can incorporate others' patented invention or published application in toto with improvements thereupon, and use the prior art as a shield when it is in the public domain;
c) Provides a way of drafting an invention disclosure that includes documented known technical components of others described in the prior art using computer search engine techniques from technical literature databases, or commercially available databases, each of which assist to teach how to make and use a proposed invention from an initial draft to the invention disclosure to seek patent protection;
d) Informs inventors, such as scientist, engineers, and laymen inventive people the significance of what prior art is and its' impact when drafting an invention disclosure, which subsequently more effectively assist patent professionals to better advise and prepare their invention disclosure for patent protection;
e) Informs inventor(s) of existing prior art that optionally can be used in whole or modified form to implement their proposed invention concept and be aspects of significance to the final invention disclosure draft;
f) Strengthens the patent system, since the USPTO, and many countries now are overwhelmed with patent applications to examine, in particular software and business method patents are very time consuming, and provide for faster examination of applications since inventors acknowledge what is prior art is known and might allow for a way of accelerated examination since the U.S., PCT and EPO applications are based upon claiming an invention based upon what the inventor believes is novel in view of prior art factors, “Jepson Claim” in U.S. (optional, see U.S. 37 CFR §1.75(e)), and required by the PCT and EPO requirements;
g) In view of recent changes to U.S. patent regulations and proposed changes to U.S. patent laws over the past several years, use of the prior art is a best way for inventors to take bites at the proverbial apple when unknown technical developments occur or new prior art development occur after filing of an initial utility patent application, potential future changes of U.S. patent law may effect both “first to invent” and ways of claiming software based technology; and
h) Allows for system design approach and affords use of freely available technology in the public domain of the patent literature to develop an inventive concept, since patent rights expire due to time-duration or non-payment of maintenance fees to the U.S. Government of U.S. patents, which then can be freely incorporated into any final invention disclosure, whereby the prior art acts as a shield using public domain patents that can be freely used and/or reduce efforts when conducting a validity search to market new product(s) or service(s). Still further advantages will become apparent from consideration of the ensuing detailed description.

### BRIEF DESCRIPTION OF THE DRAWING

FIG. 1A shows a flow diagram of the methodology of the invention from invention conception to a final invention disclosure, steps 1 and 2 are well known;

FIG. 1B shows a flow diagram of forming a document data pool related to patentabilty issues to further assist in defining the invention concept;

FIG. 1 BB shows a method of search of invention concept from an initial inventive concept at steps 1 and 2 discussed herein using a brief description of an initial inventive concept;

FIG. 1C shows a flowchart to form data pool of prior art documents related to technical enablement issues to help the inventor draft the final invention disclosure, the result of the instant invention from the initial invention concept;

FIG. 2 (PRIOR ART) shows an exemplary environment for implementing the methodology of the invention in an information technology (IT) environment;

FIG. 3 shows an exemplary software implementation of the invention using a “container” programming window format.

### DETAILED DESCRIPTION OF THE INVENTION

Inventor(s) for a utility patent in the U.S. must have (a) solution(s) to (a) problem(s) not recognized by existing technologies using component objects, (also commonly referred to as elements of a claimed invention) relating to either a composition of matter, a physical man-made component for a system, a system of components (apparatus or also known as a machine), or method of making, producing or using said objects to achieve beneficial results, and recently, business method subject matter implemented by computers.

CONCEPTION OF INVENTION: An invention disclosure with potentially patentable rights, is comprised of at least two or more conceptual objects forming a unique and unsuggested known combination in the world today, in view of public domain literature (both patent and technical literature in databases). These objects can include natural components, new combinations of basic components to form an implement, a system also known as an apparatus (a combination of implements (components)), or a method (for making or using existing implements or systems) to achieve a novel and unobvious result(s). Often, such solution(s) are made using mental free-association, based upon an inventor's heuristic knowledge, insight and/or skills to solve (a) problem(s). This is believed to be how most inventions are conceived and implemented for the benefit of humanity. These elements (components) potentially form a basis of any independent claim elements (components) when seeking patent protection. The instant invention starts with the initial invention concept, expressed as a single statement of a sentence or several sentences that is then parsable into individual word as to the elements and then forms the basis of technical data pools of patentability, enablement and enhancement as discussed bellow. Well known ways of conceiving an invention and searched are taught in at an initial stage of drafting an invention disclosure is thoroughly taught in “Patent ft Yourself” 12^{th} Edition, 2006 Nolo Press, Berkley Calif., Chapter 2 by Attorney David Pressman.

Additionally, many inventors believe that an actual building of the invention must be undertaken prior to filing for patent protection, known as “actual reduction to practice” of an invention from an initial invention concept. This is false. Inventing for patent protection can be merely mentally construed and represented by good-faith allegation based upon skills, knowledge and relying upon others who have strong knowledge in the technical arts, so long as enough technical detail is provided for one of ordinary skill in that technical art can teach others how it is made and used, without undue experimentation, a 35 USC 112 requirement. If this is the situation, a U.S. provisional patent application is the best basis to achieve priority rights of inventorship in view of current ongoing changes of U.S. patent law. Moreover, the USPTO has discontinued the “Invention Disclosure Document” filing program in early 2007 for witnessing date of conception of invention, so this is the most practical way of establishing date of conception of invention (“constructive reduction to practice”) to claim priority rights. Also known as ways of developing an invention concept for patent protection as follows:

The earliest method of inventing was “trial and error.” Inventors with no training in invention frequently had to use strategies of emulating natural system prototypes, increasing size and number, and joining objects into an effective system, then perfecting by trial and error. Inventions derived from a system design approach typically include projecting what the system has to do, evaluating what that system can and cannot do, and then identifying compromises and what new advances must be made to achieve a desired system design. This is created by joining many objects into a system and requires inventor's insight of joining at least two or more objects where no one else previously saw such a connection, an inductive approach, and subjecting the result to the “trial and error” process.

The “trial and error” approach was effectively used to its fullest extent by Thomas A. Edison, one of America's most prolific inventors. Many of Edison's over thousand patented inventions arose from systematic testing of all possible variations. To develop the alkaline cell, Edison did many thousands of experiments. He also made improvements on others' invention. For example, he improved upon Bell's initial telephone patents by designing around them, a goal of any patent system of any nation so as to promote the useful sciences. Edison also believed in using and reviewing the technical literature extensively prior to undertaking an inventive endeavor. Edison is quoted as saying, “When I want to discover something, I begin by reading up everything that has been done along that line in the past that's what all these books in the library are for. I see what has been accomplished at great labor and expense in the past. I gather data of many thousands of experiments as a starting point, and then I make thousands more.” He believed in using the prior art before undertaking the trial and error process.

A first important development of a systematic approach to inventing is often known as “brainstorming,” which was initiated in the 1930s. The crux of brainstorming is separation of ideas from evaluation, engendering an innovative and positive environment to invent generally in a group setting. This process involves free association of inventive “objects” without initial prejudice about these objects, followed by evaluation and proposal of additional inventive enhancements. This technique generally provides a way of culling ideas more often than generating them since conception of invention is usually by an individual in the group by free association, not group thinking.

Another inventing approach, which is analytic and systematic in nature, was developed in the 1940's in the former USSR called “TRIZ”. This method solves problems encountered in the development of engineered systems. TRIZ is a Russian acronym for the Theory of Inventive Problem Solving. The TRIZ methodology has been built upon accumulated technological knowledge abstracted from a systematic study of humanities history of innovation by cataloging human technological knowledge by examining, inter alia, innovative patents. The TRIZ methodology included study of patents to determine the way problems are solved and the innovative steps that lead to inventions. Thus, study of the prior art while inventing can result in technological advancement. Through the application of the TRIZ methodology, near-optimal solutions to problems can be developed using separate tools (e.g., instruments or techniques) by resolving “technical contradictions” that improve some characteristic of a system that can result in an undesirable deterioration in some other characteristic. When using classical TRIZ methodology, the process involved is one of using analogies, often distant or far analogies, to relate a generalized solution to the problem in the system under consideration. Often these analogies are in areas of technology entirely unrelated to the expertise of the involved engineer. Tools used according to the TRIZ methodology include standard solutions, principles of resolving physical contradictions; principles of eliminating technical contradictions, informational funds, and algorithm for inventive problem solving (Russian acronym ARIZ); a discussion of TRIZ and ARIZ is taught by U.S. Pat. No. 5,581,663.

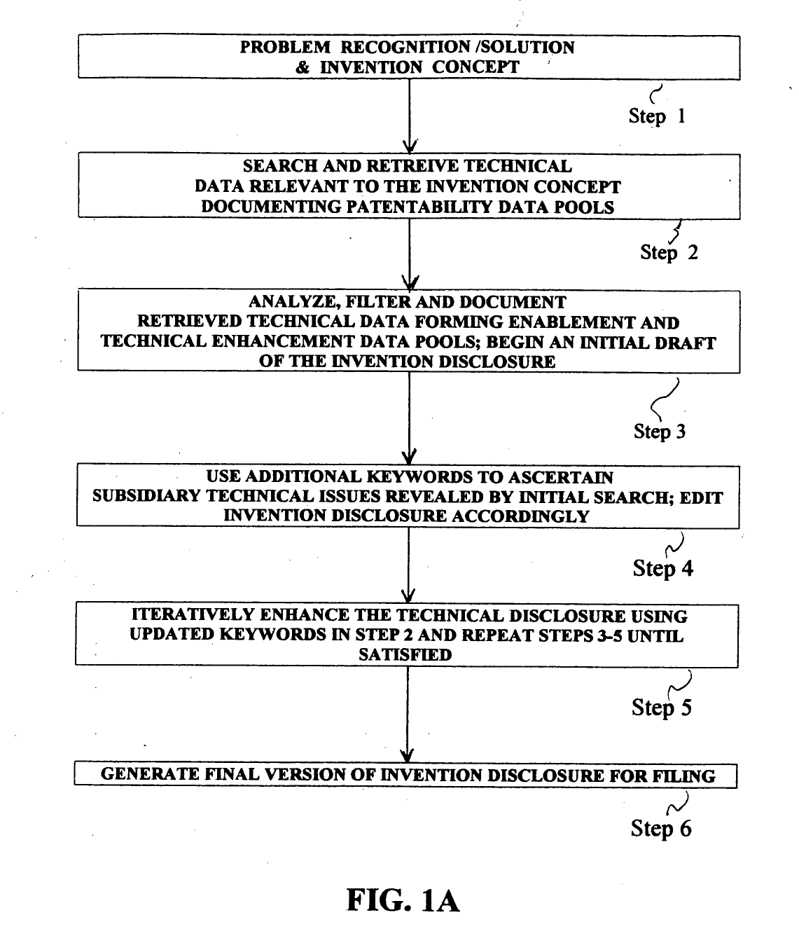

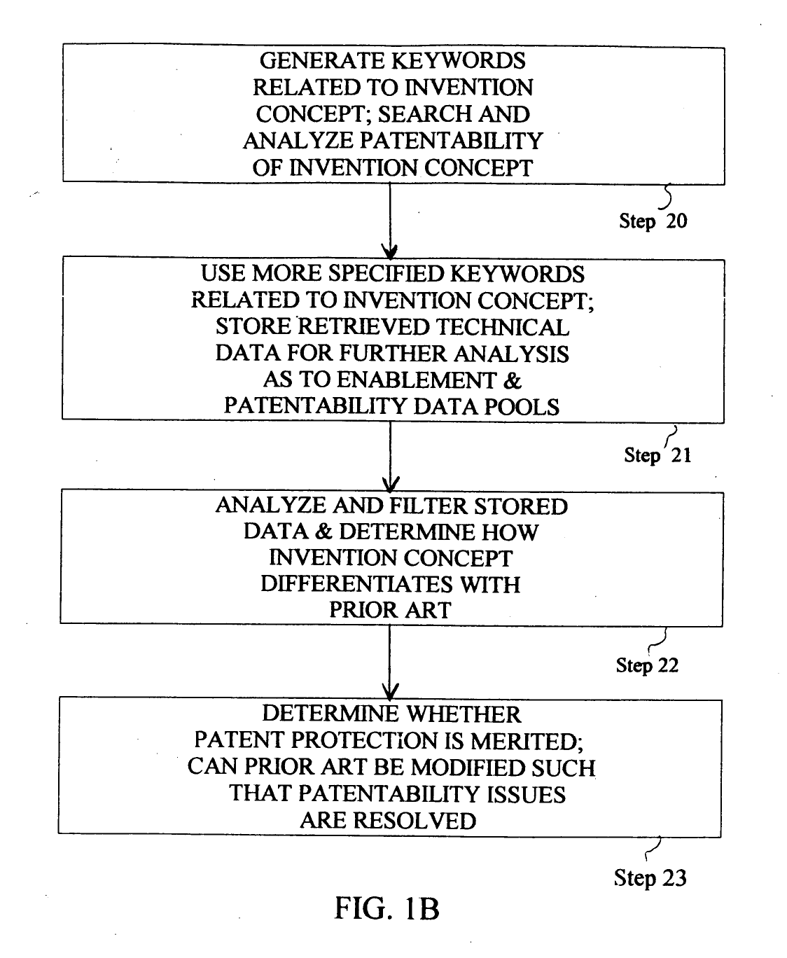

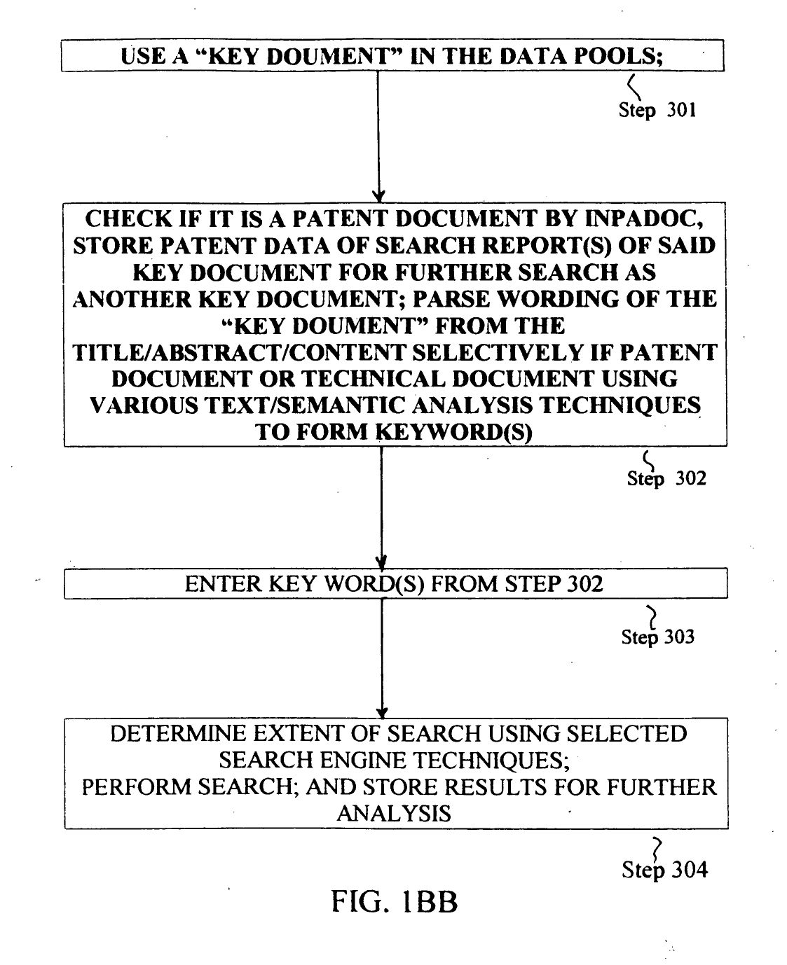

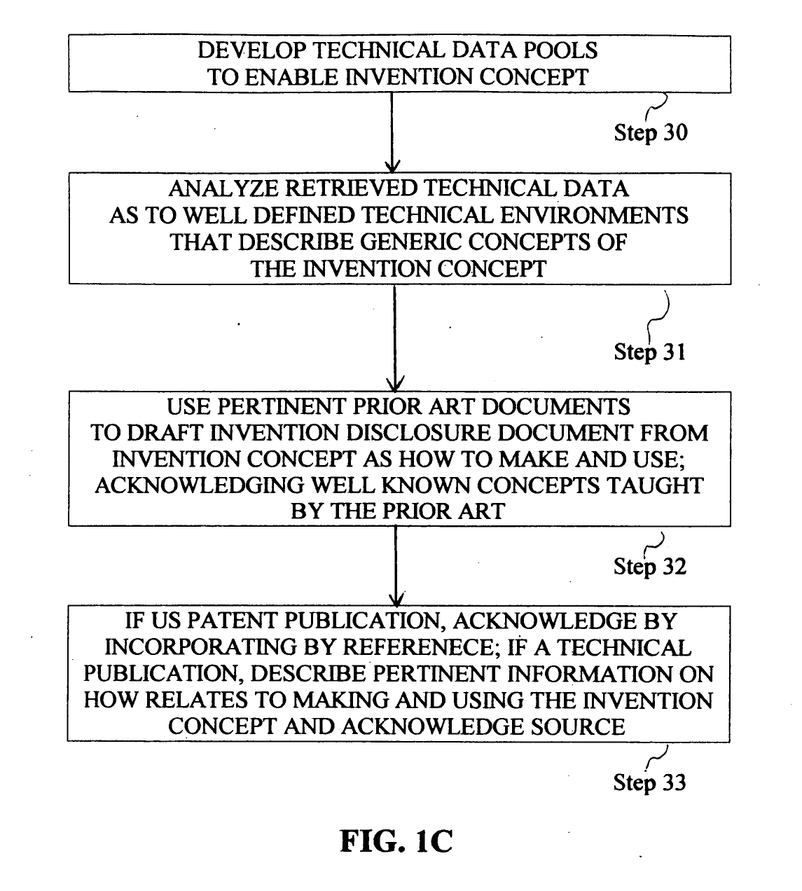

To begin use of the instant invention, an initial conceived inventive concept must be available, which is generally formulated by conceptual elements (components) derived from an inventor's ideas' of resolving a problem(s). These initial components (elements) as would appear in most independent claims of a patent, which are initially determined from the conceived invention are generally a sentence or two and form the basis of the initial “search keywords° representative of the invention concept. These components form the input data of a search engine, (initial keywords of steps 1 and 2 below) so that advanced web-based or local area network search engines can perform technical data mining of as many databases as available to the inventor(s) using either a metasearch approach or selected computer-data base search engine(s). Initial prior art documents retrieved by this search allows familiarization of prior art in view of an initial invention concept. The method of the invention as shown in FIG. 1A as procedural steps 1-6, results in the formation of the “invention disclosure”.

In the present invention, definition of an “invention disclosure,” “invention” are synonymous with “patent disclosure,” and intellectual property disclosure,” which are a document drafted and representative of many forms as either a technical report or journal article describing how it is made and used, and can be a basis for preparation as a patent application for an invention (be it paper or electronically data form), usually provided to an intellectual property manager for further action for patenting), an individual's notes and notebook, or filing document as a patent application. ° Invention concept” is synonymously known as “conception of invention,” which can ultimately results in a hypothetical patent, is the general idea that provides the initial keywords for searching the prior art, and using a novel search approach to create the final “invention disclosure,” which in turn forms the basis of either a provisional or regular patent application in the U.S. or a PCT/EPO application if filing abroad. “Prior art” is a publication readily available to the public at large and can take many forms as a publication, be it paper or electronic form such as a web page. A thorough discussion is provided by the USPTO website by an article entitled “When is an Electronic Document a Printed Publication for Prior Art Purposes?” written by Wynn W. Coggins of the USPTO 2002, which is “incorporated by reference.” “Incorporation by reference” is defined as a shorthand way of including a document in another so information does not have to be repeated in a drafted document. Current U.S. practice allows for only issued U.S. patents and published patent applications where the information is essential when describing how to make and use and invention concept, (defined as “essential subject matter”). Non-essential matter teaches of background information as to the state of the technical art, which can also be incorporated by reference and also use patents or printed applications, be they U.S., EPO, PCT or other foreign country, and non-patent publications, (U.S. 37 CFR §1.57).

Use of the present invention requires an IT system for software programming, preferably in a “container” type of software application form, or incorporate and invoke special web-site tools using a web browser application for ease of focusing all search and document drafting tools in a single invention disclosure application as similarly taught in U.S. patent application 20070124166 A1, using the prior art as a technical basis as to determine technical precedent reference(s) that accomplish the goals of an initial invention concept. Note that many of the websites taught herein may change in the future due to business mergers and/or the vagaries of time where business go under. The instant invention provides for integration of many patent-related functional software tools (some commercially available now and/or patented/patent pending or in the public domain) that optionally may be used on a fee/licensing basis to implement the instant invention, as required by the inventor(s). An inventor can determine whether prior art patents are worth incorporating in the invention that may be currently enforced through maintenance fees and warrants use with the invention since it may still be enforceable due to lack of an expiration date or unpaid maintenance fees, thus in the public domain. Such a determination allows for free use of previously enforceable patent concepts, now in the public domain. A website that currently provides such information is www.patentmonkey.com that is being absorbed into www.patents.com soon that in the future allows for marketing and licensing currently enforced U.S. patents, using web-site approaches as taught in U.S. published patent application 20070124166 A1. The method of the invention also enables iterative search and documentation of the prior art so that subsequent enhancements of a draft version of the invention disclosure can be undertaken prior to final submission of the invention disclosure to a technology manager for preparation as a patent application. Use of the container format allows for incorporation of a web browser application along with document preparation that can effectuate many of the search aspects of the invention and make use of built-in features of the web browser application, such as tabbed browsing, add-on features of the browser, book marking of tabs representative of selected database websites, reopening of a whole group of bookmarks. Many browsers allow for added search bar tools to be incorporated (e.g. Google, freepatentsonline.com, etc.) at various search engine websites, add-ons and plug-ins and extensions that appear as tabs or smaller windows (tools and utilities using Microsoft's Explorer browser or Mozzila's Firefox). Web browsers also now allow for the user to subscribe to real time web site feeds using XML (programming used to send feeds) or really simple syndication (RSS) wherein the user subscribes to Internet information sources using an Internet web page having an aggregator (programming reader) or RSS reader to obtain real time information. As shown in FIGS. 1A, 1B, 1BB and 1C, the method of the invention is as follows, note that steps 1 and 2 are standard procedure most patent professionals use today, wherein the searching feature shown in FIG. 1BB is novel by using parsing of word in the “key document” be it a patent document, technical document and other forms of prior art literature so as to seek out other documents pertinent to the patentability, enablement and enhancement data pools:

Step 1: The initial search includes use of a computers graphical user interface (GUI) can access and store documents using keywords that pertain to the concepts of the invention by searches of selective databases or documents obtained from the Internet as now provided by Google's patent search engine capability, or any of the world's patent database websites such as the EPO, PCT or U.S. patent authorities. Alternatively, based upon the complexity of the invention concept, a metasearch search engine capability may be required such as Ask.com, Draze MetasearchAccess (draze.com), www.copemic.com or dogpile.com that can use an alternative search engine capability, without effective information filtering to obtain potential alternative technical information related to keywords of an inventive concept. These techniques are well known and taught in books such as of “Patent it Yourself” 12^{th} edition Chapter 3 of David Pressmen as discussed above. Also, when using a web browser function, particular databases can be used to find technical data related to the invention. Such databases include the USPTO's patent search engine capability, freepatentsonline.com, Google's patent search engine database capability, or the EPO website with international patent search capability at ep.espacenet.com, with abstracts to over 50 million patent documents at this time in various languages, all for public use.

Additionally, the USPTO has over 1,300 Search Templates corresponding to its' over 600 classification categories of invention for electronic searching the prior art, (see their website as to templates for electronic searching and the U.S. classification breakdown, although not available to the public at this time since it is a governmental function, but may become). Moreover, various subscription fee-based databases are available for searching patent literature that are not searchable from either the free USPTO or EPO patent search databases. This may change since the USPTO is overwhelmed with applications to date and need assistance by applicant.

Commercial databases, e.g. ICO Global Patent Search at PatentCafe.com, Delphion, Inc. or Questel Orbit, are fee based subscription service websites. If using the U.S. Patent Office web site's patent database to search the prior art, U.S. and international patent classification(s) are instantly revealed to provide additional “keys” as to an index of patent literature related to any invention concept that can narrow and focus a search of any invention concept. Related keywords can then be readily obtained and freely available by reviewing the U.S. Patent and Trademark classification database available from the USPTO website. Additionally, a patent that relates to this concept is taught in U.S. Pat. No. 6,662,178.

Optionally, as to plug-in applications with the instant invention, where automated methods are desired to create search queries, retention of such queries, and organization of IP information derived from a searching process using automated means include U.S. Pat. Nos. 6,662,178 or 6,694,331, which are hereby incorporated by reference, which are substantially now used freely freepatentsonlne.com, and be a plug-in with the instant inventions implementation when using a web-browser based software format, which can also be add-on tabs of the browser or appear continuously with other sub-windows of a container application single screen view as discussed below. Moreover, freepatentsponlne.com can be incorporated with the web-browser application using the instant invention since it now offers both RSS feeds of U.S. patents weekly published by the USPTO, and this site offers free storage of desired patents as to search results. They work independently or can be part of a larger application, and can be used accordingly, if incorporated in the browser section of the invention's software. Additionally, mining of technical data is readily available from professional technical journals, magazines and conference proceedings published by various technological society publications, (e.g. IEEE's technical publication Components, Packaging and Manufacturing Technology Society is available in either a CD or web-based subscription format through IEEE/IEE Electronic Library and Software Patent Institute). Many of these technological society publications generally incorporate search engine capability at their web site to interrogate technical information provided only through their publication. Moreover, particular technical fields of endeavor can be reviewed most often through abstracts of technical papers abstracted and indexed at by their database alone, e.g. health research publications are most readily discovered at the National institute's of Health's (NIH) website called PubMed. The PubMed database has abstracts of medical research papers using keywords abstracted from the technical paper and usually published and not searchable over the Internet. Such a way of obtaining current research from these non-searchable journal articles will tell how research was performed and discovered. This is important, since an inventor can then use this information to correlate with their knowledge and previous knowledge obtained. Use the patent information as a basis for a facet of any of the components such that the technical expertise of others substantiates what you claim as the invention, since each piece of patent literature focuses on one category of invention.

However, if the invention concept is mechanical in nature, review of the patent literature drawing is the primary way of determining whether an invention is novel since mechanisms do not allow word search alone, since drawings speak the proverbial thousands of words. Mechanical aspects of mechanical based inventions should be serially searched based upon USPTO and International patent classification using a computer patent database such as the USPTO, Google or freepatenntsonline.com index patent literature to such a classification and allows serial review of these indexed patent/application drawing. Note that the international patent classification (IPC) has changed recently and be consulted for classification changes, as does access to the World Wide Web. This search is important because inventor(s) are alerted to what is known and then informs as to what is prior art, and also be used as prior art against their invention when seeking patent protection.

Information filtering is another important aspect of the instant invention. Patent professionals use “cached” or “highlighted” text (e.g. Google patent search engine, USPTO patent data search and commercial patent search engines as offered by Delphion or Questel), note the USPTO subscribes to approximately 900 commercial databases which are available if a public user at the USPTO located in Alexandria, Va., if readily available to the public, and should since it is publicly financed, and assist in filtering information related to an invention and selecting the most relevant prior art, and assist the patent examiner in view of the complexities of patent prosecution by laymen or patent professional. This search forms technical data pools discussed below, that expand until the final invention disclosure as claimed herein. This is an initial step assist initially, but only as to initial findings regarding a technical search, well known by patent professionals and important since “key documents” may be revealed in this step. If not, step 2 is pursued in greater detail by using more sophisticated search or metasearch engine strategies that may satisfy the initial inquiry whether to further pursue the invention or require greater search of the prior art using advanced search engine technologies of patents/applications and other technical documents.

Step 2: when keywords reveal too many articles not relevant to an invention concept, resulting from step 1, then additional or more focused keywords must be used in the search to find novelty aspects of the invention concept. This is accomplished by either deletion or combining words as part of the search using standard Boolean logic (and/or and not) or quotations or parenthesis around grouped or separated words as required by search engine or metasearch search engine. Note, this is well known in the art and if fee-based usage is available, use Delphion.com that includes access to Derwent or use the PatentCafe.com since they have a unified approach of international databases that search simultaneously from a singe database, but require paid subscription.

Additionally, some patent databases, such as the EPO patent literature database have search capabilities of only the title, inventor(s), assignee and abstract of a patent document. Similar to Delphion.com capabilities of only the front page being searched. This can be useful during an initial search since information is filtered as to the gist of prior art that is usually related to the inventive concept. These will form technical data pools as to patentability, enablement and technical enhancement issue relevant to the invention concept and forming the basis of a draft of any invention disclosure, as discussed below.

As shown in FIG. 1B, this search strategy reveals technical data as to literature related to patentability issues provided wherein novelty (a one-on-one correlation with the inventive concept is revealed by a single document) and/or obviousness (a combination of technical literature teachings encompass the components of the invention concept) may be revealed by the search. At this time, inventor(s) determine whether further effort is merited in view of the initial invention concept. At step 20, the inventors form an initial pool of patentabiliy technical references as to their initial invention concept. If the initial search reveals too many references, more particular words must be used at step 21. Filtering is critical since too many technical documents may preclude determination of these important patentability issues. By using more specific keywords pertinent to the invention concept, a more related pool of documents is revealed that may reveal a difference in components or steps of the invention concept that are then further analyzed at step 22. If the invention concept has novel components or steps at this step, determine whether obviousness issues are revealed as by teaching, suggestion or motivation? This aspect is usually a suggestion as to a modified making or using of the U.S. patent publication and appears at the end of a patent document as alternative aspects of the invention. If so, maybe the invention concept has to be either modified so that another problem is resolved, or abandoned at step 23.

As an alternative search strategy, patent literature obtained during the initial search may reveal the most related patent to the invention concept in the patentability, enablement and enhancement data pools. This is critical as afforded by the following example.

For example, as an initial starting point, using steps 1 and 2 above, my invention concept is saving electrical energy for portable or central air conditioning units, most do not incorporate a water mechanism to cool condenser coils during hot summer days as a retrofit kit, saving 20-30% electrical usage during peak electrical demand, which would represent substantial savings to electrical utilities since outages are minimized and electrical transmission from other areas is obviated. I initially use the uspto.gov website to determine if such a unit is in the patent literature. I use the phrases “air conditioner” and “water cooling” and “condenser” for all words in the patent literature database using standard Boolean logic. The initial search reveals 21 U.S. patents that are received and stored, reviewed accordingly. The titles do not include inferences of use for outside air conditioning systems for homes or small buildings. Another search is performed at step 2 performed that reveals many more patents, a review of the patent titles show several that are more related to the concept of residential units as conceived by the invention, a review of this patent literature reveals the nearest applied technology. I then use steps 1 and 2 of the instant invention, finding U.S. Pat. No. 4,542,627, a direct hit on the conceptual aspects of the invention. I do not have to further search technical arts and not use this subroutine of the invention. Thus, there is no need to pursue further prior art searching to make and use a proposed invention since it already exists. I check to see if this patent is either in the public domain and no patent rights exists or expired at monkeypatents.com due to non-payment of fees.

Such considerations provides incentive and a basis to form a business enterprise to produce and sell to consumers and/or provide an incentive for electric utilities to supply to and provide rebates to customers due to great expense during peak demand in the summer months, much like on/off switches are used today. If this method is further required at this juncture, the method is continued as follows.

FIG. 1BB illustrates an examiner's search approach in a flow diagram that can be implemented in software format for use in either a web-browser form of software or container format using the IT computer system 200. A “key document” is requisite to use of searching the prior art literature to seek additional data of the patentability, enhancement an enablement data pools. For example, the drafting of this final version of the application entailed a prior art search of recently cited documents that forms a new integral part of the invention disclosure. In particular, U.S. Pat. No. 6,662,178 was searched again as to “referenced by” section as searched at the uspto.gov patent search website. Often concepts are further revealed that have no bearing on keywords used in a search. To my interest, U.S. Pat. No. 7,296,015, as taught above, discloses many search strategies that can be used against an alleged patent infringer and dissects the wording of the independent claims of a subject patent by parsing and filtering words of that patent, which is hereby incorporated by reference with the following modification.

This patent's search strategy can be used to determine the prior art. In particular a method of using its' search strategy includes using on a search text section that parses out words such as a verb(s) and/or nouns and enters the data into a search window strategy as to “title,” and “abstract text” automatically, such as at the espacenet.com or uspto.gov web sites to determine the best prior art for search using either the patent authorities or commercial databases as listed herein to search out any documents relevant to an inventive concept. The search strategy is taught by independent claim 51 of U.S. Pat. No. 7,296,015, as to a search strategy, wherein U.S. Pat. No. 6,662,178 was one of the earlier patents that found this patent without particular keyword searching as taught by steps 1 and 2 above. Note that the patentable limitation(s) of this patent was the limitations of a “chat room” or automatic “claim chart diagramming” apparent patentable limitations of the independent claims. Modifications and improvements upon the search aspect is where it can be used for an initial novelty search of the prior art, as discussed above, which can be inputted as a sentence or two as to the components forming the invention (see conception of invention discussed above) and implemented by a layperson as a sentence by inputting an idea of their initial invention concept as discussed in steps 1 and 2 above combined, or be used as to seek out enhanced prior art as to enablement or enhancement issue concepts when performing updated searches in real time development of an invention disclosure.

As another modification to this invention, the key word search terms are entered into the well known bibliographic data fields of either patent literature databases or search engines automatically and iteratively checked weekly as to any of the data pools, thereby determining new prior art as to the patentability issues that may effect the broadest aspects of the inventive concept and/or require modification, enablement data pools that give further definition to certain components of an invention, for example new materials discovered if a composition of mater form of invention, or enhanced forms of search engine technology and so on.

Again, the “key document” is one that allows for parsing words from either the title, abstract if so indexed, and/or use keywords forming part of the key document or the key document itself that facilitates another method of searching either a LAN or WAN database or use web sites such in-house patent and technical literature databases or e.g. Google or other over the Word Wide Web when using. Usually, these brief description of the article allows parsable into component elements forming keywords) entered into either a search or metasearch engine that allow for search in a detailed manner documents accessible through various databases, which focus on aspects of either patentability issues (critical for determining whether to further develop the invention concept as to novel and unobvious requirements for patent protection) enablement issues (teaches one of ordinary skill in the art how to make or use components of the invention in refined detail a to well known components used in a method or system form of claiming an invention concept), and enhancement data pool, wherein information learned by doing the prior search for whatever pool, brings to the attention of the inventor(s) of the invention concept, ideas unknown and may further enhance the value of the invention.

At step 301, the “key document” of particular relevance as to patentability, enablement or enhancement pools is entered into the search or metasearch engine and analyzed by processing computer 200 to search out relevant prior.

At step 301, as an example, the inventor(s) can enter one or more of the most patent number(s) or published patent applications of interest to focus on issues of one of the patent data pools, wherein the processing computer retrieves the patent literature from this text information from either the local or wide area network from computer 200 remote assorted databases. In another preferred embodiment, the patent text information can be entered into and/or loaded into the processing computer 200 at step 301.

At step 302, the processing computer 200 can process and/or parse one or more of the entire patent texts or only its' bibliographic text on a front page of any patent document using various search engine techniques and/or the entire content of the document by search engine technology presently available. The processing computer 200 can use any one or more text analysis processing techniques, and/or semantic analysis processing techniques, of bibliographic information first page of any patent application document. For example, the processing computer 200 can search the patent document in either the title, abstract, inventor or owner of the patent using various search fields by accessing stand alone search engines such as the EPO, USPTO, or WIPO databases (the EPO website is probably one of the most important patent authorities in the world today since such information covers over 60 million documents inclusive of the USPTO, WIPO, JP and PCT and INPADOC information as to the front page bibliographic text of these patent literature), freepatentsonline.com or if a paid subscription, a metasearch engine approach using PatentCafe's ICO search engine (a website previously known as Shadow Patent Office spo.com and previously now part the PatentCafe.com) that used search engine technology of any document of interest related to search terms developed for the U.S. Central Intelligence Agency, Lexpat.com or Delphion.com that has all the international databases and INPADOC (a database part of ep.espacenet.com, having potential information since it reveals all information of a patent application in the world and usually has a search report of significance that can become a key document to be used in this search. In system 200 information is transmitted through the WAN or LAN systems to access these databases or organizations having very large databases of information of relevance (patent and technical literature used in-house of an organization).

At step 302, the processing computer 200 identifies all relevant patent documents then stores these patents in the particular patent data pools of interests related to the search. Moreover, if using INPADOC in any of these search approaches, patent documents often have a search report, provided by the EPO and PCT search authorities that provide information of potentially more relevant information. These search reports often contain relevance of prior art cited as being either novel by an “X” or obvious by a “Y” in the claimed combination as reported by the search of that particular application. This is important since these patent/technical literatures use semantics of wording having similar aspects of the concepts of interests in the “key document' being examined.

In particular, the instant application determined newly discovered prior art using this method of the invention from such a search report during preparation of said patent application while reviewing a citation of “referenced by' section at the uspto.gov patent search website since they used words of another patent found through the INPADOC and revealed by a PCT search report. The data entered revealed many new patents related to search technologies and assisted in “enablement” issues in drafting this application since the “key word” used in the application was the broadest term possible “intellectual property disclosure” also can be considered an “invention disclosure,” since trademarks and copyrights also are encompassed by this term. A thesaurus may not pick the right words all the time to focus on “key words” necessary to pick the most relevant prior art. This is part of the search strategy and is a subroutine action of the method. If a PCT or EPO document of significance, then such results are reported. It is always the key to other relevant documents in any search. This search entail whether other patents may encompass the core patentable aspect of the invention's inventive concept, filed in the patentability pool, related text information in a memory location or storage area if required at a later date. Alternatively, if an “X” or a “Y” is determined to be in “Search Report” findings, these patents are stored and retrieved accordingly for later search at step 301 and form the basis of another search of this search method strategy.

At step 303, the processing computer 200 can process and/or parse the text of a certain key document at step 301 to identify and store the either bibliographic text (title or abstract information in patent literature) or keywords usually present on the front page of a technical literature document with abstract, abstract information or a technical document or even key words associated with keywords of the key document of interest at step 301. In a preferred embodiment, the independent claim text information is used to perform the analysis routines described herein as keywords can typically be viewed as containing the broadest descriptive information of the key document.

The IT computer 200 can perform any and/or all of the processing routines described herein for all of the patent documents forming the patent data pools as described.

At step 304, the processing computer processes and/or parses the text information of an abstract and/or title of an key document fields typically available from both single search engine database sites and/or metasearch database Web sites as discussed above. The IT computer 200 can use any one or more of any suitable word processing searching technique, text analysis processing techniques, and/or semantic analysis processing techniques, to find and/or identify a key word(s), term(s), phrase(s), acronyms.

The IT computer 200 can process and/or parse the text information of either a title or abstract of a “key document” to identify invention components for patent literature in the patentability data pool, enablement data pool, or enhancement data pools. In a preferred embodiment, the processing computer 200 can use any one or more of any suitable word processing searching techniques, text analysis processing techniques, and/or semantic analysis processing techniques, to find and/or identify a key word(s), term(s), phrase(s), acronyms, symbols and so on. If a patent document, the IT computer 200 determines what related patents of the invention are revealed by the search engine and stored accordingly, much like the USPTO EAST search engine as to forward and backward citations related to the invention.

Upon the completion of steps 304, the IT computer 200 will have ascertained and stored information, including key words and/or terms, regarding either the patentable inventive concept, enhancement issues of the technical aspects of the invention, or ways to enable making or using the invention to which the conceived invention is so directed.

At step 305, the processing computer 200 can formulate and/or construct a search and/or a search query to perform a search of the prior art using initially the patent literature databases as discussed above and/or technical databases as discussed herein. The processing computer 200 performs a search of any relevant database or databases to identify prior art, which may be of use to the data pools.

In a preferred embodiment, the present invention can use a Boolean search and/or a Boolean search query and/or any other form of search and/or search query. In the preferred embodiment, the search and/or search query can be formulated by using the key words, terms, and/or other information, regarding the conceptual component(s) related to the interest of the data pools discussed above. The search and/or search query, in the preferred embodiment, can be formulated by using any synonyms, dictionary definitions, equivalent terms, foreign language translations, and/or slang terms, etc., which may be associated with, and/or which may be customarily used for, or in place of, any of the respective key words, terms, and/or information.

The IT computer 200 can formulate the search and/or search query by use information stored in the database, which can, for example, include dictionary information, thesaurus information, industry atlas information, product information, services information, and/or any other information which can be utilized to formulate a more complete and comprehensive search or search query for, or regarding, the key words, terms, and/or information, identified as being associated with and/or corresponding to the product(s) and/or service(s) to which the independent claim is directed and/or to any of the invention conceptual to provide adequate enablement aspects, determine enhancement issues of components of the invention.

As an exemplary embodiment, the processing computer 200 can perform a search involving and/or including any number of databases and/or information sources, including, but not limited to, any one or more of those mentioned in steps 1 and 2 above such as the patenting authority databases, a Delphion database, a Derwent database, and/or any of the database(s), information source(s) herein.

In the preferred embodiment, a user can also pre-define and/or pre-select criteria regarding an accuracy or an integrity of a search. For example, a user can select any percentage number defining a search integrity or accuracy. For example, a user can pre-define a search to include or contain 60%, 70%, 80%, or 90%, of the words, terms, and/or information, contained in the search or search query. Any percentage number can be pre-defined and/or pre-selected, and/or can be pre-programmed into the processing computer 200. If for example, a 60% accuracy number is defined, then the processing computer 200 can perform a search and obtain results which can include information regarding a component of the invention concept, products, a business service, and/or services, wherein the resulting information can contain at least 60% of the key words, terms, and/or information, contained in the search and/or search query.

Any accuracy or integrity percentage can be pre-defined and/or pre-selected. In a preferred embodiment, the search results can also include results wherein key words, terms, and/or information, of the search and/or search query can be found in a same sentence, in a same description, and/or within a pre-defined proximity to other key words, terms, and/or information as is currently available by most search strategies using many of the patent and technical databases discussed herein.

In a preferred embodiment, the IT computer 200 can search and analyze web page content and/or web site content for any invention components from invention concept, or examining elements of an independent claim to do a validity search as discussed below, by searching out the prior art as to the patent literature, product(s) and/or business service(s) available over the World Wide Web which are, or which may be, the same as, an equivalent of, similar to, and/or analogous to, the product(s) and/or service(s) to which the independent claim is directed. In a preferred embodiment, the IT computer 200 can also search and analyze the content of a web page or web pages and/or a web site or web sites in order to locate, identify, and process technical information and/or aspects of the any of the information in the data pools as described.

The IT computer 200 can also use various searching tools, programs, intelligent agents, search engines, search engines such as Ask.com, Web Ferret, Google, etc., web site directories, search engine directories, hierarchical directories, and/or techniques in order to search any number of web sites and/or server computers on the Internet and/or the World Wide Web. The updated information is processed in real-time in accordance with at selected time intervals during iterative processing of the invention disclosure, seeking out data as to both validity search of patent applications pending with an opposition period for third parties to present undiscovered prior art and validity searches of existing patents when third parties desire to challenge the validity of an issued patent using either a reexamination or judicial declaratory/infringement situation.

Step 3: As shown and expanded in FIG. 1C, the inventors reviews and selects and documents relevant information from the initial search as to an invention concept forming enablement and enhancement technical data pools at step 30, that provides descriptive information on how to make and use the invention concept. The prior art generally will show and teach some aspect of the components used in the invention concept. This forms a collection of prior art listing of the most relevant prior art data. At step 31, analyze the initial data pool as to relevant prior art that is closely related technically with respect to the invention concept that reveals either how the cooperative components that are novel and/or how the one or more components of the invention concept has novel features that resolve the problem/solution of the invention concept. Pools of technical data form around the each of the components of the invention concept. Additionally, “ancillary components” may form around the invention concept that may provide added value to the invention when used. Generally, these are existing known concepts that may exist as a commercial product or method and/or reduced to IP form as patents, copyrighted material or merely described in non-patent literature, which can be an additive mutually exclusive feature of the invention concept, and be an issue when seeking IP protection of the invention concept. Herein, the instant invention refers to these additive components as “plug-ins,” which can be claimed in dependent claim format if essential to steps 1-6 of the instant invention or provide enhanced enablement and best mode aspects until satisfied with step 6 of the invention disclosure.

At step 32, drafting of the patent disclosure using the pertinent pools of prior art is strategized to buttress the invention concept is begun describing how the components of the invention concept are made and their use. These pools of prior art are used to show the state of the technical art and accentuate the novelty of components and how the problem/solution is resolved by the invention concept. Additionally, using these pools of prior art information as generated at step 30 buttress the invention disclosure by revealing what is well known in the prior art by defining the environmental use of the invention using a efficient drafting technique known as incorporating by reference at step 33. If using the U.S. patent literature, the referenced patent document may be “incorporated by reference” in toto, or portions may be extracted by cutting, pasting and modifying the technical information into a proposed patent disclosure since it is a Government publication and not copyrighted (note that this copied technical information may be actively protected by a patent, be patent pending or be in the public domain since some patents expire before expiration since maintenance fees were not paid). As discussed above, if the information is essential subject matter as to the components of the invention concept, then only published U.S. patents or published patent applications can be incorporated by reference. If non-essential subject matter that is used to show the state of the art or provide ancillary explanation to essential subject matter, then the gamut of technical information can be incorporated by reference, including non-patent literature as discussed above. Note that this is the most efficient use of time when drafting the invention disclosure since reinventing the proverbial wheel is obviated (note that most inventions are improvements on what is known). Henry Ford stated this similarly in his statement I invented nothing new; I simply assembled into a car the discoveries of other men.” If a technical publication, it is generally copyrighted and must be credited and described accordingly.

Information in the data pools are enumerated, dated and highlighted by an identifiable technical data pool log for witnessing and dating conception of a proposed invention. This feature allows modifications of existing patented or published text, without allowing changes to be made to the reference document. This is automatically documented and transformed by a listing, witnessing, and highlighting action as shown by a technical data reference. Such a method of annotation and documentation of a reference document (i.e., a patent document, a copyrighted technical article, etc.) is taught and provided by Microsoft in its U.S. Pat. No. 7,028,267, hereby incorporated by reference. Note that if prior art exists that performs a function or enhances the inventive concept, use an existing U.S. patent or published U.S. patent application by using the legally recognized phrase Incorporated by reference” as to the referenced patent document, and then explain how it enhances the invention concept. If a subsidiary feature (non-essential subject matter) of one of the components and explains how to make or use the inventive concept, then other foreign and patent documents and non-patent literature can also be used. Alternatively, published U.S. patent application U.S. 2004088332 A1, hereby incorporated by reference, teaches of an IP database management tool that allows for annotation of patent literature that can also be used. By creating listings of the prior art documents and marking up the document as to use with the proposed invention concepts, reference can be made accordingly, and use in the browser section as a tab at freepatentsonline.com.

Step 4: The search results in step 3 is significant by providing additional and more specified key-words that will allow further refinement for searching a proposed invention and adding additional information surrounding the invention concept. By learning from the pools of data information previously retrieved, analyzed and documented, one can modify the search by use of words as selected by the inventor. Repeat the search again with alternative words as to your invention's concept(s). Then collate and integrate additional technical components and details not earlier discovered during initial search(s) of a proposed invention. Often, a research article in a particular undertaking provides data as to related work, which may be of great import since it provides other leads as to companies, inventors and cross-reference to other related patent literature. A collection of information will form about the idea you are searching and you will discover that they are a new and improved combination during this step. As shown in FIG. 1C, use the prior art as a technical reference as showing how to make and use an invention. In particular, from an initial search, learn aspects afforded by the prior art and incorporate with your invention disclosure. Use well-known technical information and label as (prior art) in drawing since invention is distinguished by technical precedent and be so acknowledged in the final invention disclosure.

Step 5: Collate and update selected technical data gathered from the technical and patent literature data over time. By iteratively developing an invention disclosure over time, subsequent editing and/or change in emphasis of the invention can be made (e.g. a new problem/solution issue is resolved as to one of the components obtained from one of the data pools) as to patenting the initial invention concept. If planning to draft the disclosure over a span of about a year, file one or more U.S. provisional patent applications during this time period to establish date of conception and constructive reduction of practice to establish invention priority rights, if the invention concept is in an actively pursued area of technology since an interference of the claimed invention concept can still occur until the U.S. Government harmonized with other countries of the world. Moreover, for small inventors who do not have the wherewithal like big organizations that can beat most small inventors to the patent office if a first to file basis is implemented, use of the instant invention will allow for a one year grace period to file a regular utility application in the U.S. and still have a chance of being the first to invent, one of the major concerns of changing from a first to file basis. Use of the provisional patent application is evidenced by how the instant invention was developed over a one-year period and does not entail all the requirements of a regular utility patent application, merely updating editing and documenting how to make and use the invention concept in view of newly discovered prior art during the drafting of a final invention disclosure for filing as a regular utility application. Also, edits, updates and modifications of an initial provisional patent application can be corrected by filing subsequent provisional applications that incorporate the parent provisional application within this one-year grace period, wherein a regular utility application incorporates the provisional patent applications as filed, and subsequent new matter changes can be made to the initial invention concept up until filing of a regular U.S. utility patent application.

This step is critical since many prior art patent/technical literature documents are continually revealed during the drafting phase of the invention disclosure until a final disclosure is revealed. Additional review of most relevant prior art patent documents in relation to the initial and potentially modified invention concept (prior art in the patentability data pool) are often cited by the patent authority during examination of these weekly issued patents and published patent applications, which can affect the viability of the patent concept. Moreover, related published patent applications appear weekly as well that may relate to the invention concept, which may either enhance or affect the drafting of the invention disclosure. If the novelty of the invention concept is taught by the recent discovered prior art, further effort may not be warranted. Otherwise this step of the disclosure drafting process iteratively enhances the invention concept and the steps 2-4 are repeated until satisfied with a final invention disclosure.

Step 6: This step documents and memorializes the invention disclosure as a final document for filing as required. Various methods can be used for this purpose. A) In an inventor(s) notebook, using a print out of the existing disclosure, using standard forms of acknowledgement and witnessing, at least two witnesses acknowledge they have read and understood the invention disclosure. B) Inventors can file the invention disclosure and assert constructive reduction to practice by filing a U.S. provisional application to establish date of conception and reduction to practice, as discussed above, since the U.S. is still a country that bases inventorship on a first to invent interference proceeding. (Note that the U.S. Congress has proposed patent legislation that would do away with this interference procedural aspect of patenting an invention. If this is the case, inventors of little means are encouraged to file early and often using a provisional patent application to have patent pending status of their invention concept.) C) Use an electronic format of witnessing an invention disclosure as afforded by U.S. Pat. No. 6,418,457, which teaches of an IT based patent disclosure storage and processing system for inventors to provide electronic witnessing of an invention disclosure to evidence date of invention, which can be a plug-in feature of the instant invention. D) File a regular U.S. utility patent or PCT application over the Internet or in paper form and designating the U.S. as one of the filing countries. Many commercially available U.S. patent application-drafting tools can be plug-in software of the container form of programming to draft the final disclosure. Several of these applications are described above such “PatentPro,” by Kernel Software or other invention disclosure application as licensed software as discussed above.

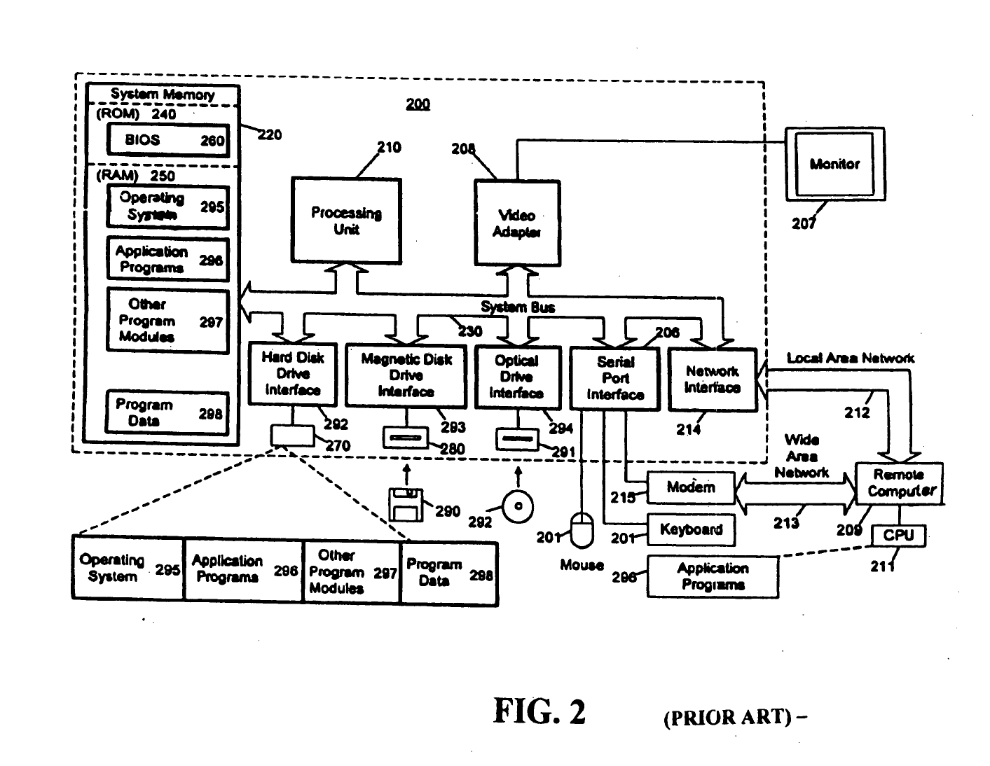

The present invention is preferably implemented by a software application typically on a PC computer alone or as part of a local area network within a larger IT system. FIG. 2 (Prior Art) shows such an implementation and hereby incorporated by reference and repeated herein since it is well known and taught thoroughly by U.S. Pat. No. 7,028,267, from Microsoft. A unitary PC computer 200 is capable of supporting concurrent execution of a plurality of software application programs 296 capable of using a graphical user interface (GUI) display function, now well known in the computer technologies. The graphical user interface is a software system that allows a user to directly manipulate the application programs by conventional I/O devices such as a CRT display 207, a keyboard 201, or a mouse 201, or other user specified device, or all of them if desired as is shown and are well known in the IT arts shown in FIG. 2 (Prior Art). A file manager is part of the operating system and can open, maintain, and close files on behalf of the operating systems requisite interface functions using a GUI capability. The file manager also operates in conjunction with one or more peripheral storage devices 292, 280, 291 as shown. In addition, each application maintains its own window configuration buffer, which is used, when the application executes, to keep the current parameter values definitive of the current configuration of the application's window. Furthermore, portions of data, or objects, can be shared between the different applications. The interface functions can manage and control the contents of a “container” application having multiple active applications operating in a single viewable setting. Word processing applications are just one of the application programs 296, e.g. Microsoft's Word program stored in hard disk drive 270.

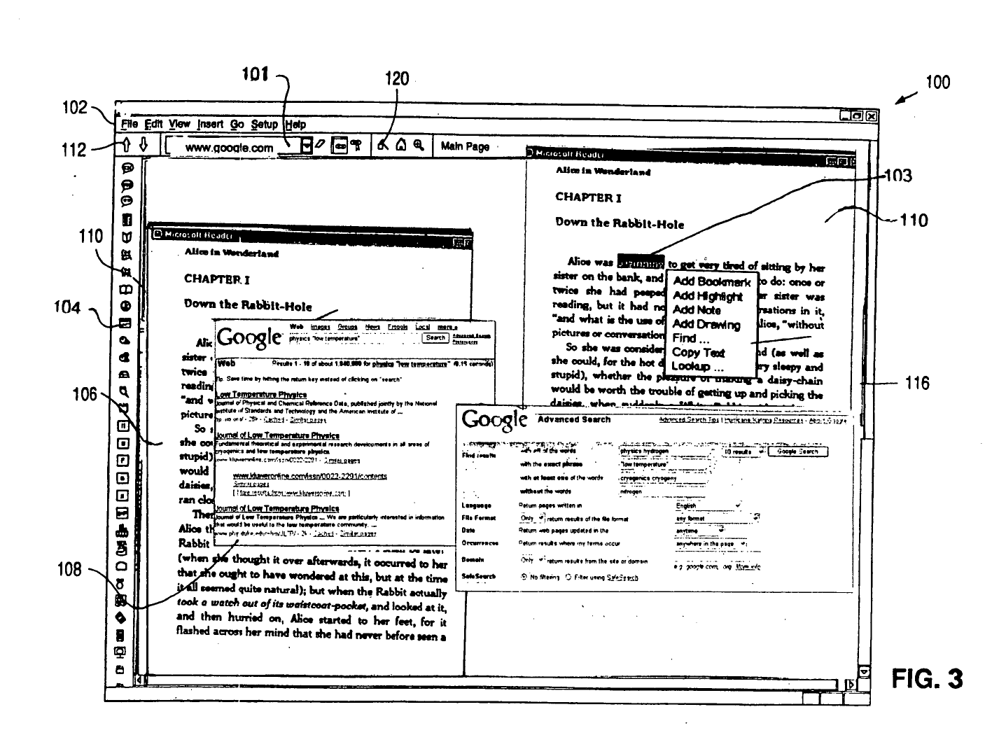

Although the invention is typically used on a PC having a (GUI) operated by a Microsoft operating system, the container software application 100 can readily be implemented on alternative operating systems in current use, e.g. LINUX operating system. The interface function application is a software program written in well-known programming languages, such as C, C++ or Java and is translated or executed on the PC processor 200. The preferred interface functioning is an exemplary container application 100 shown in FIG. 3 that encompasses multiple applications using Microsoft ActiveX/OCX “object” technology, or AJAX for implementing these application objects in a container application using requisite functionality of the instant invention to implement search, updated technical feeds in view of focused data information sources and scribe functions. It is understood, however, that some of the application programs 296 can be from any application that meets the application program interface specifications of the GUI.

Implementation of the invention requires programming in a “container” application format having web-browser capability 101. The container window environment provides both drafting capability as shown as scribe document 106 constituting any single version of the invention disclosure along with search capability of both in other object windows either accessible from application objects in 104 or web-browser functionality 101, all viewable on a monitor screen or multiple screens as desired. Many web sites now have live real-time feeds of information that the inventor may be able to access using either XML (programming used to send feeds) or Really Simple Syndication (RSS), such as provided in select technologies by freepatentsonline.com. The browser function 101 incorporates this as a prescribed Internet web browser reader function using an aggregator (programming reader) or RSS reader for real time data from such subscribed web-site sources to any of the search engine strategies listed above in FIG. 1 BB. As an example, many world patent offices may in the future enable such capability such that weekly published patent documents and/or technical journals can be accessed.

By integration of many functional tools for drafting an invention disclosure in either a well tabbed/modified browser or container application, which either provides both focused websites and applications to provide ease of use to an inventor from interested novice to patent professional, efficient development of a final invention disclosure results and helps the patent examining authority much of the needed prior art to do a more thorough examination since the inventor(s) are seeking a stronger and more informed application for the public benefit, since updated technical data occurs daily in the world everyday which may effect an inventor's initial conceived invention and any patent is considered a claim against public domain use. The invention allows for iterative search and discovery of new prior art or previously undiscovered prior art from new technical data cross-referenced technical data, which can be correlated as well for a better understanding of the prior art.

The container application 100, shown in FIG. 3, implements search functioning using either a web browser 101 or search functioning from data sources within the local area network. Function requisites of the container can be implemented as an “applet” when using Java programming language developed by Sun Microsystems, Mountain View, Calif. The standard HTML and XML syntax of Web pages and the standard communications protocol (HTTP) supported by the WWW guarantee that any Web browser can communicate with any Web server. Java programming language provides architecture independence of programs written in the JAVA language that allows a user to assemble programs from components that are distributed on diverse Internet nodes or to download entire program folders from other Internet nodes and use applets as required.

Multiple technical data application objects based on ActiveX object designs using the API of Microsoft operating system, which can be linked to databases over the local or wide area networks 212, 213. These objects can include multiple patent search authorities such as www.patentsforfree.com, the U.S. or EPO Government's Internet Web sites at (www.uspto.gov) and (ep.espacenet.com), World Intellectual Property Organization at www.wipo.int/tacsy and more recently Google's patent search of U.S. patents with actual document display capability at www.google.com/patents. Each of these web sites has their own search capability and are free to use. Also, on paid subscription databases, pre-1976 word-based data search capability can be used by such providers as Delphion, Questel or Orbit, fee-based subscription services.

The present invention requires a master scribe invention disclosure document that will ultimately provide the final patent disclosure document. This is word processing application 110 as shown in FIG. 3 (e.g. Microsoft's Word).

Referring now to FIG. 3, an invention disclosure/technical search container application window 100 is shown. This window typically appears on a display 207. The window 100 includes a browser application 101 for accessing the Internet or intranet, a menu bar 102, a prescribed application object execution button bar 104. Icon bar 104 is generated by a separate window having a menu selection having various data search sources, scribe functions, time-stamp and archive programs, stored separately in program selection 296 or stored remotely from a server source over local area network (LAN) 212 or wide area network (WAN) 213. One such application program is invention disclosure scribe application object 106. The scribe application object in simplest form is a word processing application such as Microsoft's WORD or Corel's WordPerfect, PatentEasy as used by the PCT authority or any commercially available patent application preparation software application as described above in the Background section of the instant invention to prepare a utility patent application, e.g. U.S. Pat. No. 6,574,645 and family of patents, U.S. patent application 2004/0128623 A1. Note however any word processing application can be used and activated by menu bar 104.

An Internet web browser search application 116, such as Google, ((108) results shown of a search) is used to find technical data. Other such free search engines including MSN, Yahoo, and so on, which can be used as a search engine. Others that may be activated by menu bar 104 include selected commercial databases that are available either over the LAN 212 or on WAN 213 by using their data functions. This enables technical data search capability from third party information providers (paid for intellectual property research databases such as Delphion, Orbit, or Questel) using either intranet LAN 212 or WAN 213, wherein an inventor can access all this information simultaneous on a single screen.

Any article or patent literature 108 findings of the search are copied and documented in a table of relevant documents and stored showing time a date of interests. Finalized documentation of relevant technical data search results (either patent literature or technical articles) can be edited and pasted into the patent disclosure scribe document 106 to develop a patent disclosure that records and optionally time-stamps current version of an invention disclosure to establish time of discovery and relevance to the patent disclosure 106. The application 100 has Web browser capability with capability of using third-party information sources via input data drives 270, 290, 291 of PC 200. A number of different data base providers, for example include technical journals on DVD or CD-ROM, i.e. IEEE Societies CD publications as to electronic technology that is published by their Components, Packaging and Manufacturing Technology Society, which can be read by the optical drive device 291 or remotely over LAN 212.

Adjacent basic container functions are provided at the top of the application object display as button tabs 102 for control of the container, each of which identifies functionality aspects such as printing, technical searching services, or time-stamping for documenting a disclosure and the like within one of application object programs 104. The sub-window display objects 106, 108, 116 and 110 are controllable program objects using the Microsoft-based OCX container-type programming.

The instant invention shown in FIG. 1A represents the invention in either a method and/or system format that uses steps 1-6 discussed above. Exemplary form is shown in FIG. 3 for possible continual iterative development of resultant invention disclosure 106. A basic search engine well-known and widely used search engine application 108 is Google, shown in FIG. 3.

Optionally, commercially available software can be used in the disclosure as discussed above as plug-ins as applications 104 and executed as required. The table of these applications that can be subscribed to and added to available applications as part of container 100, depending on skills and needs of the individual preparing document 106. As to Steps 1 and 2 shown in FIGS. 1A & 1B, the graphical user interface accesses and stores documents using “key words” that pertain to the concepts of the invention by searches of selective databases or documents obtained from the Internet as provided by Google's or Yahoo's search engine web sites 101. One object window 106 of the GUI must have a word processor to accept the invention disclosure. Access and obtain all information related to these keywords using various search engines to retrieve information related to your invention. Others that can be incorporated include databases with much technical data, (but not inclusive). As an example, see freepatentsonline.com, the European Patent Office, the U.S. Patent and Trademark Office, Google, Yahoo, MSN, or various subscription-based databases at the subscribers discretion (i.e. Delphion, Inc., a paid data base subscription). If the U.S. Patent Office web site's patent database is used, U.S. and international patent classification is instantly revealed which can be used as a “key” to review the patent literature to search your invention. These key words are freely available by reviewing the U.S. Patent and Trademark classification database. Use them. Using “cached” or ° highlighted” text (i.e. as provided by the Google or U.S. Patent & Trademark Office databases) helps in filtering information related to an invention inquiry and selecting the most relevant prior art teachings.

Optionally, plug-in applications can be used with the present invention, where automated methods are desired to create search queries, retention of such queries, and organization of IP information derived from a searching process using automated means, use software provided by U.S. Pat. Nos. 6,662,178 or 6,694,331, hereby incorporated by reference, which can be used with the present invention as discussed above as plug-in application and executed by icons 104, alternatively, use steps shown in FIG. 1 BB.

As to Step 3: The inventor(s) reviews and selects relevant technical data from this search as to their proposed invention forming the technical data pools. This forms a clipboard listing of the most relevant information that is highlighted for use in the disclosure that is enumerated, dated and highlighted by the an identifiable log for witnessing and dating conception of a proposed invention and be in one of the data pools. This feature, as shown as object document 110 in FIG. 3, allows modifications of existing patented or published text, without allowing changes to be made to the reference document. This is automatically documented and transformed by a listing, witnessing, and highlighting action as shown by a technical data reference by use of button 102. Such a method of annotation and documentation a reference document 110 (i.e., a patent document, a copyrighted technical article, etc.) is taught and provided by Microsoft in U.S. Pat. No. 7,028,267, hereby incorporated by reference. (Note that if it exists and performs a function, use an existing U.S. patent or published patent application by Incorporating by reference) and then explain in text how a proposed invention disclosure differs by describing and showing how it is both novel and non-obvious. As an alternative, published U.S. patent application U.S.2004088332 teaches of an IP database management tool that allows for annotation of patent literature that can be modified for use as an annotation tool as well. This can be important as to establishing priority of invention issues when a potential interference action may be invoked during patent application prosecution since the U.S. is still a first to file based patent system as to inventorship.

As to Steps 4 and 5: The search in step 3 is continually repeated using more exact and specified key documents in any of the data pools, key-word(s) in the search engine that further refines searching of a proposed invention when preparing the an invention disclosure in either one session of use or over a period of time where updates are made to the invention disclosure. Most patent literature publishes weekly and often must be further reviewed prior to submission to see if the most relevant aspects of an invention disclosure are still novel and unobvious. Additionally, subsidiary issues can be further gleaned to refine such aspects prior to final submission of the invention disclosure. By learning from information previously retrieved and analyzed, one can modify the search by use of other words as selected by the inventor. Repeat the search again with alternative words as to your invention's concept(s). Collating and integrating additional technical components and details not earlier discovered during initial search(s) of a proposed invention are then incorporated in disclosure 106. Also, updated searches after filing a final invention disclosure and in a regular utility patent application can be monitored by using the enhanced search capability of the instant invention.

As to step 6, the final invention disclosure is memorialized take many formats such as an inventors notebook or be a document or a file in an IT file storage location. As discussed above, the inventor(s) can file in any of these formats in the USPTO as a means of constructive reduction to practice by using a U.S. provisional application to establish both date of conception and priority rights to their invention. Use of such a technique allows for edits, updates and modifications of an initial filed provisional patent application by filing subsequent provisional applications within a one-year time frame prior to filing of a utility patent application in the United States. Also, filing of a provisional patent application in the USPTO provides an efficient means of proof on inventorship since the Government is witness as to date of invention and may be of value to small inventors in view of proposed changes to U.S. patent laws by changing from a “first to invent” to a “first to file” basis as to determination of inventorship of a patented invention. If using a notebook aspect to protect an invention concept, use of an electronic format of witnessing an invention disclosure is so provided by U.S. Pat. No. 6,418,457, which teaches of a software based patent disclosure storage and processing system for inventors, which provides electronic witnessing of an invention disclosure to prove date of invention, which can be one of the plug-in software applications 104 for use with the instant invention. The final invention disclosure document is ultimately filed with a technology manager or in a U.S. patent application form that can use any of the commercially available software as discussed in the background section above.

As to use of the present invention, the current invention disclosure is an example of using the method of the invention. To repeat, a problem is the basis of all invention origins. From my previous experience, most inventors do not understand what prior art is or its significance once they obtain a patent. Such a problem forms a basis for resolution for drafting an enabling invention disclosure. The instant invention provides an effective way of developing a stronger patent disclosure when compared to typical drafting techniques of an invention disclosure wherein the inventor usually does not actively search the prior art to his benefit while iteratively enhancing the content of the disclosure.

In conclusion, inventors who actively research prior art relevant to their inventive concept by using the instant invention often discover either they possess a technically broader invention disclosure and/or may strengthen a resultant patent issuing from their invention disclosure since the prior art defines what is invention. Moreover, the present invention potentially rewards an inventor by combining others' patented invention or published applications forming part of their invention disclosure since much of the prior art is in the public domain and be freely used to start a business if followed exactly how to make and use of an expired or unpaid fees to maintain a U.S. patent in force. This can promote new business products/services for mutually agreed parties as to an invention by assigning, licensing or cross-licensing IP technology. Also, new businesses can form by using aspects of expired patents either as a stand-alone product/method for business use or be part of a complicated method or system, although these forms of inventive concepts may still be under patent protection since it is encompassed by an earlier patent (a pioneering patent) that may still be in force. Such determination is made by a validity search. The instant invention simplifies this task.

As a variation to the invention, the method of the invention can also be used to challenge validity of existing patent and pending published patent application in either litigation scenario or an administrative course of action using the USPTO. In particular, see U.S. Code of Federal Regulation at 37 CFR §1.99 and 1.291, wherein a third party (any member of the public) can challenge the alleged claims of a pending application within two months after publication of the patent application or before notice of allowance respectively, which is filed with the examining group within the USPTO. This may change soon since Congress is now proposing legislation for an “Opposition Proceeding” to be handled by the USPTO. If after issued as a patent, a third party can also file the pertinent prior art in the issued patent file wrapper history by the USPTO under 35 USC 301 (see CFR §1.501). Also reexamination can be undertaken to challenge a patent by a third party or the patent owner.

By actively searching the prior art as discussed above, the independent claims that are at issue have elements that are comparable to components of an invention concept. As to novelty issues, if any single prior art document teaches of all the claimed elements, wherein the claim is interpreted by its' ordinary meaning, then the independent claim is invalid. As to obviousness issues, when two or more prior art references when combined read on the claimed elements of the invention, and there at least one of the prior art either teaches, suggest or motivates one of ordinary skill in the art for doing so, then it may be obvious, pending a Governmental opinion or decision for stating as such. Moreover, the U.S. Supreme Court recently modified guidelines as to determining obviousness issues in an important 2007 case known as KSR International Co. v Teleflex Inc., wherein the prior art does not necessarily have to teach, suggest or motivate one of ordinary skill in the art to combine the elements in a claimed combination to be obvious (note that obviousness is a conclusion of law, and more difficult to reach a finding on compared to novelty issues). The question is “whether the improvement is more than the predictable use occurs when combining the prior art elements according to their established function, to yield the claimed invention.”

As this sub-aspect of using the invention, the step 1 can be used for determining and challenging validity of a published patent documents. The step 1 would be modified by parsing the subject patent document's independent claim(s) into searchable elements for intensive prior art searching. Each of these elements also known as invention components are searched in steps 2-5, with the exception that no invention disclosure is drafted, only a pool of patentabilty technical data constituting prior art that was not previously discovered either during patent examination (opposition allowed) of an issued patent in question as to a validity search.

Relevant prior art data is forwarded to the USPTO by filing for a reexamination proceeding of an issued patent, or to the patent examiner to challenge a pending published patent application under 37 CFR §1.99 and 1.291. Also Law 35 USC 301 (CFR §1.501) allows a passive way for any member of the public to enter pertinent prior art in the file wrapper maintained by the USPTO not used during patent prosecution of an issued patent free of charge, although the patent in question is still valid until decreed otherwise by reexamination or review by the U.S. Courts.

As to defining well-known equivalents to describe a method using software, it is likewise well known to equate as such with a description of a system for performing the method in the software arts. The system can include, e.g., a PC and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the method of the invention. Thus, various combinations of hardware and software may be used instead of software only. The term “computer-readable medium” refers to any medium that participates in providing data (e.g., instructions, data structures), which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

Various forms of computer readable media may be involved in carrying data (e.g. sequences of instructions) to a processor. For example, data may be (i) delivered from RAM to a PC processor, (ii) carried over a wireless transmission medium; (iii) formatted and/or transmitted according to numerous formats, standards or protocols, such as Ethernet (or IEEE 802.3), SAP, ATP, Bluetooth™ TCP/IP, TDMA, CDMA, and 3 G; and/or (iv) encrypted to ensure privacy or prevent fraud in any of a variety of ways well known in the art.

Thus a description of a method is likewise a description of a computer-readable medium storing a program for performing the process. The computer-readable medium can store (in any appropriate format) those program elements, which are appropriate to perform the method.

Just as the description of various steps in a process does not indicate that all the described steps are required, embodiments of an apparatus include a computer/computing device operable to perform some (but not necessarily all) of the described method.

Likewise, just as the description of various steps in a process does not indicate that all the described steps are required, embodiments of a computer-readable medium storing a program or data structure include a computer-readable medium storing a program that, when executed, can cause a PC processor to perform some (but not necessarily all) of the described method. It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. An automated method for searching an invention over an extended time period corresponding to assessing and pursuing rights of patentable protection using an information technology (IT) system, parsable into component(s) to the IT system, each said component parsable by a text analysis method revealing at least one salient feature related to at least one keyword of said invention and performing a search query of said at least one keyword by a search engine and retrieving relevant prior art forming a patentability document data pool related to said invention, comprising steps for
a) analyzing said patentability document data pool related to said invention forming at least one key document(s); and
b) periodically and automatically searching on a continual basis for new prior art over said extended time period at designated time intervals referencing said at least one key document(s) and documenting said new prior art, whereby said new prior art references said at least one key document(s) and facilitates ease and accuracy of assessing patentable rights of the invention automatically over said extended time period.

2. The method of claim 1, wherein formation of said patentability data pool in the step a} includes:
generating a listing of said relevant prior art as to said data pool to form said key document(s);
highlighting information in said relevant prior art that is redacted in said invention; and
documenting said highlighted information for drafting a statement as to said invention.

3. The method of claim 1, wherein the searching to determine relevant prior art forming said data pool includes inputting and processing said at least one key document(s) by the IT system;
identifying at least said one keyword related to said invention as relates to said patentability data pool;
formulating said search query containing said at least one key word;
performing a foreign language translation of said at least one key word if said key document does not correlate with said search engine requirements to perform a search query of said key document;
using said search engine using said query; and
automatically outputting prior art documents to said patentability document data pool.

4. The method of claim 3, wherein the step of identifying comprises: parsing the text information of the key document to identify the searchable terms of the key document.

5. The method of claim 3, wherein the method uses at least one of a word processing searching technique, a text analysis processing technique, and a semantic analysis processing technique, to identity words of a brief description of the at least one key word.

6. The method of claim 5, further including parsing the information contained in the key document to identify text information corresponding to a primary search aspect of the at least one key word.

7. The method of claim 1, wherein said at least one key document is a patent document wherein said search engine accesses patent database International Patent Documentation Center (INPADOC), wherein said patent document includes an international search report having either an “X” or “Y” document in a search report in accord with international treaty said “X” and “Y” document forms said new prior art as said key document(s).

8. The method of claim 1, wherein the step b) for searching the new prior art referencing said at least one key document is weekly, and documenting said new prior art.

9. The method of claim 1, wherein said at least one key document is a patent document wherein said search engine accesses a patent database, wherein said patent document is the key document that is a basis for a forward citation search and any new findings forms said new prior art as said key document(s).

10. An automated method for searching an invention over an extended time period corresponding to assessing and pursuing rights of patentable protection using an information technology (IT) system, parsable into component(s) to the IT system, each said component parsable by a text analysis method revealing at least one salient feature related to at least one keyword of said invention and performing a search query of said at least one keyword by a search engine and retrieving relevant prior art forming a patentability document data pool related to said invention, comprising steps for
a) analyzing said patentability document data pool related to said invention forming at least one key document(s); and
b) periodically and automatically searching on a continual basis for new prior art over said extended time period at designated time intervals referencing said at least one key document(s) and documenting said new prior art, whereby said new prior art references said at least one key document(s) and facilitates ease and accuracy of assessing patentable rights of the invention automatically over said extended time period;
wherein said at least one key document is a patent document wherein said search engine accesses patent database International Patent Documentation Center (INPADOC), and wherein said patent document includes an international search report having documents related to patentability in a search report in accord with international treaty, wherein said documents related to patentability forms said new prior art as said key document(s).

11. An automated system for searching an invention over an extended time period corresponding to assessing and pursuing rights of patentable protection using an information technology (IT) system, parsable into component(s) to the IT system, each said component parsable by a text analysis method revealing at least one salient feature related to at least one keyword of said invention and performing a search query of said at least one keyword by a search engine and retrieving relevant prior art forming a patentability document data pool related to said invention, comprising means for
a) analyzing said patentability document data pool related to said invention forming at least one key document(s); and
b) periodically and automatically searching on a continual basis for new prior art over said extended time period at designated time intervals referencing said at least one key document(s) and documenting said new prior art, whereby said new prior art references said at least one key document(s) and facilitates ease and accuracy of assessing patentable rights of the invention automatically over said extended time period.

12. The system of claim 11, wherein formation of said patentability data pool in the means for a} includes:
generating a listing of said relevant prior art as to said data pool to form said key document(s);
highlighting information in said relevant prior art that is redacted in said invention; and
documenting said highlighted information for drafting a statement as to said invention.

13. The system of claim 11, wherein the means for b) of searching to determine relevant prior art forming said data pool includes inputting and processing said at least one key document(s) by the IT system;
identifying at least said one keyword related to said invention as relates to said patentability data pool;
formulating said search query containing said at least one key word;
performing a foreign language translation of said at least one key word if said key document does not correlate with said search engine requirements to perform a search query of said key document;
using said search engine using said query; and
automatically outputting prior art documents to said patentability document data pool.

14. The system of claim 13, wherein the means for identifying comprises: parsing the text information of the key document to identify the searchable terms of the key document.

15. The system of claim 13, wherein the system uses at least one of a word processing searching technique, a text analysis processing technique, and a semantic analysis processing technique, to identity words of a brief description of the at least one key word.

16. The system of claim 15, further including parsing the information contained in the key document to identify text information corresponding to a primary search aspect of the at least one key word.

17. The system of claim 11, wherein said at least one key document is a patent document wherein said search engine accesses patent database International Patent Documentation Center (INPADOC), wherein said patent document includes an international search report having either an “X” or “Y” document in a search report in accord with international treaty said “X” and “Y” document forms said new prior art as said key document(s).

18. The system of claim 11, wherein the means for b) for searching the new prior art referencing said at least one key document is weekly, and documenting said new prior art.

19. The system of claim 11, wherein said at least one key document is a patent document wherein said search engine accesses a patent database, wherein said patent document is the key document that is a basis for a forward citation search and any new findings forms said new prior art as said key document(s).

20. The system of claim 19, wherein the forward citation searching is weekly.
